(19) United States
(12) Patent Application Publication
(10) Pub. No.: US 2010/0248068 A1
(43) Pub. Date: Sep. 30, 2010

(54) FUEL CELL STACK, FUEL CELL, AND METHOD OF MANUFACTURING FUEL CELL STACK

(76) Inventor: SHOJI SEKINO, Tokyo (JP)

Correspondence Address: Mr. Jackson Chen, 6535 N. STATE HWY 161, IRVING, TX, 75039, US

(21) Appl. No.: 12/706,768

(22) Filed: Feb. 17, 2010

(30) Foreign Application Priority Data
Mar. 30, 2009 (JP) 83778/2009

(51) Int. Cl. H01M 8/10; B23K 11/00

(52) U.S. Cl. 429/465; 219/117.1

(57) ABSTRACT

A fuel cell stack includes two or more cells. The cell includes a solid polymer electrolyte membrane, a porous metallic cathode, and a porous metallic anode. The cathode is arranged on one surface of the solid polymer electrolyte membrane through a catalyst layer. The anode is arranged on the other surface of the solid polymer electrolyte membrane through a catalyst layer. Two or more cells are connected in an electrically conductive manner by resistance welding of the cathode of one of the cells and the anode of the other one of the cells with a conductive metallic foil interposed therebetween.

### INCORPORATION BY REFERENCE

This application is based upon and claims the benefit of priority from Japanese patent application No. 2009-83778, filed on Mar. 30, 2009, the disclosure of which is incorporated herein in its entirety by reference.

### TECHNICAL FIELD

The present invention relates to a fuel cell stack, a fuel cell, and a method of manufacturing a fuel cell stack.

### BACKGROUND ART

Reduction in size and weight of a polymer electrolyte fuel cell using liquid fuel can be readily made. Therefore, nowadays, research and development are advanced for application of the polymer electrolyte fuel cell as a power source to various types of electronic devices such as portable devices.

The polymer electrolyte fuel cell is provided with a cell including a structure in which a solid polymer electrolyte membrane is held between an anode and a cathode. A fuel cell of a type of directly supplying liquid fuel to the anode is referred to as a direct type fuel cell. An electric power generation mechanism thereof is as follows. The liquid fuel supplied to the anode is decomposed on a catalyst supported by the anode. Due to this decompose, protons (cations), electrons, and intermediate products are generated. The generated protons (cations) pass through the solid polymer electrolyte membrane to a cathode side. The generated electrons move to the cathode side through an external load. Then, the protons and the electrons react with oxygen in the atmosphere at the cathode to generate a reaction product. This reaction allows the fuel cell to generate electric power. An example of the fuel cell includes a direct methanol fuel cell (hereinafter to be referred to as a DMFC) that directly uses an aqueous methanol solution as the liquid fuel. In the DMFC, the reaction represented by the following chemical formula (I) occurs at the anode and the reaction represented by the following chemical formula (II) occurs at the cathode.

CH₃OH+H₂O→CO₂+6H⁺+6e⁻ (I)

6H⁺+6e⁻+3/2O₂→3H₂O (II)

An electric power-generating site of a polymer electrolyte fuel cell includes an electric power-generating minimum unit, which is called a cell, as a basic component. The electric power-generating site is configured of a fuel cell stack in which the cells are electrically connected. This fuel cell stack is mounted to a structure that supplies fuel or extracts electric power. In this manner, the polymer electrolyte fuel cell can be used as a power source. In the polymer electrolyte fuel cell, for example, according to required voltage, plural cells are connected to configure a fuel cell stack.

Such fuel cell is used as a stationary external battery charger or a power source of small devices such as cell-phones and the like, for example. In such intended use, since it is mainly used away from home, a smaller fuel cell is required. Therefore, a power collector for collecting electric power extracted by the cell is usually used. This power collector is fixed to the fuel cell with relatively weak force such as screw. Further, in view of efficiently utilizing oxygen in the atmosphere at the cathode and efficiently utilizing water and methanol in the fuel at the anode, it is preferable that a contact section between the power collector and the cathode and the anode is as small as possible. Therefore, the power collector preferably holds a limited part of the cell.

An example of a method for reducing the size of the fuel cell includes a method in which a power collector is omitted or downsized. As such methods, a method in which an anode and a cathode of two or more cells are connected only through a metallic rivet (Japanese Patent Application Laid-open No. 2008-177047 and WO05/45970), a method in which a power collector (connector) is connected to an anode and a cathode of two or more cells by resistance welding, and the anode and the cathode are connected through the power collector (connector) (Japanese Patent Application Laid-open No. 2007-273433), and a method in which electrodes and a power collector such as a terminal (tab) is connected by resistance welding (Japanese Patent Application Laid-open Nos. 2005-5077 and 2006-107868) have been proposed.

### SUMMARY

An exemplary object of the invention is to provide a fuel cell stack that includes a simple structure, suppresses increase in connection resistance at a connection site of a cathode and an anode, and achieves high connection intensity at the connection site; fuel cell; and a method of manufacturing a fuel cell stack.

According to an exemplary aspect of the invention, a fuel cell stack includes two or more cells including a solid polymer electrolyte membrane; a porous metallic cathode; and a porous metallic anode, wherein the cathode is arranged on one surface of the solid polymer electrolyte membrane through a catalyst layer, the anode is arranged on the other surface of the solid polymer electrolyte membrane through a catalyst layer, and the two or more cells are connected in an electrically conductive manner by resistance welding of the cathode of one of the cells and the anode of the other one of the cells with a conductive metallic foil interposed therebetween.

According to another exemplary aspect of the invention, a fuel cell includes the fuel cell stack; and a fuel supply portion, the fuel supply portion including a fuel container; and a gas-liquid separation membrane, wherein the fuel supply portion is arranged at an anode side of the fuel cell stack through the gas-liquid separation membrane, and gaseous fuel is supplied from the fuel supply portion to the anode through the gas-liquid separation membrane.

According to yet another exemplary aspect of the invention, a method of manufacturing a fuel cell stack includes providing two or more cells, the two or more cells including a solid polymer electrolyte membrane; a porous metallic cathode; and a porous metallic anode, the cathode being arranged on one surface of the solid polymer electrolyte membrane through a catalyst layer, and the anode being arranged on the other surface of the solid polymer electrolyte membrane through a catalyst layer; and connecting the two or more cells in an electrically conductive manner by resistance welding of the cathode of one of the cells and the anode of the other one of the cells with a conductive metallic foil interposed therebetween.

### BRIEF DESCRIPTION OF THE DRAWINGS

FIG. 1A is a plan view showing a structure of an example of a fuel cell stack according to a first exemplary embodiment of the present invention.

FIG. 1B is a cross-sectional view of the fuel cell stack taken along line I-I of FIG. 1A.

FIG. 2A is a plan view showing a structure of another example of a fuel cell stack according to a first exemplary embodiment of the present invention. FIG. 2B is a cross-sectional view of the fuel cell stack taken along line II-II of FIG. 2A.

FIG. 3 is a plan view showing a structure of yet another example of a fuel cell stack according to a first exemplary embodiment of the present invention.

FIG. 4A to 4E are views for explaining an example of a method of manufacturing a fuel cell stack according to a first exemplary embodiment of the present invention.

FIG. 5A is a plan view showing a structure of an example of a fuel cell according to a second exemplary embodiment of the present invention. FIG. 5B is a cross-sectional view of the fuel cell taken along line of FIG. 5A.

FIG. 6A is a plan view showing a structure of another example of a fuel cell according to a second exemplary embodiment of the present invention. FIG. 6B is a cross-sectional view of the fuel cell taken along line IV-IV of FIG. 6A.

FIG. 7A is a plan view showing a structure of a fuel cell used as a reference example in an example of the present invention. FIG. 7B is a cross-sectional view of the fuel cell taken along line V-V of FIG. 7A.

### EXEMPLARY EMBODIMENT

Hereinafter, a fuel cell stack, a fuel cell, and a method of manufacturing a fuel cell stack of the present invention will be described in detail. However, the present invention is not limited to the following exemplary embodiments.

### A First Exemplary Embodiment

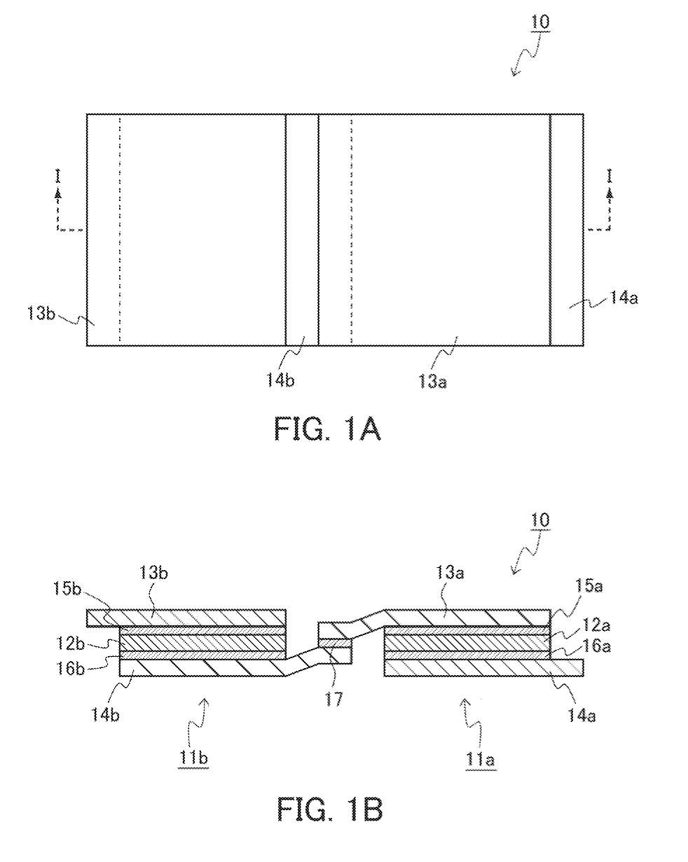

A structure of an example of a fuel cell stack of a first exemplary embodiment is shown in FIG. 1. FIG. 1A is a plan view of a fuel cell stack of a first exemplary embodiment. FIG. 1B is a cross-sectional view of the fuel cell stack taken along line I-I of FIG. 1A. In FIGS. 1A and 1B, identical parts are indicated with identical numerals and symbols. As shown in FIGS. 1A and 1B, a fuel cell stack 10 includes two cells 11a and lib as main components. The cell 11a includes a solid polymer electrolyte membrane 12a, a porous metallic cathode 13a, and a porous metallic anode 14a. The cathode 13a is arranged on one surface (upper surface in FIG. 1B) of the solid polymer electrolyte membrane 12a through a catalyst layer 15a. The anode 14a is arranged on the other surface (lower surface in FIG. 1B) of the solid polymer electrolyte membrane 12a through a catalyst layer 16a. One end of the cathode 13a is protruded from one end (left end in FIG. 1B) of the solid polymer electrolyte membrane 12a. One end of the anode 14a is protruded from the other end (right end in FIG. 1B) of the solid polymer electrolyte membrane 12a. The cell 11b includes a structure similar to that of the cell 11a. One end of a cathode 13b is protruded from one end (left end in FIG. 1B) of a solid polymer electrolyte membrane 12b. One end of an anode 14b is protruded from the other end (right end in FIG. 1B) of the solid polymer electrolyte membrane 12b. The protruded end of the cathode 13a and the protruded end of the anode 14b are welded by resistance welding with a conductive metallic foil 17 interposed therebetween. Thereby, the cell 11a and the cell lib are connected in an electrically conductive manner. In the fuel cell stack of the first exemplary embodiment, cells are connected in an electrically conductive manner, without requiring an extra component such as a power collector or the like, by welding the porous metallic cathode and the porous metallic anode by resistance welding with the conductive metallic foil interposed therebetween. Therefore, the structure thereof is simple. Further, as compared to a case of directly welding a cathode and an anode by resistance welding, when the cathode and the anode are welded by resistance welding with a conductive metallic foil interposed therebetween, an area of a connection site of the cathode and the anode can be increased. Therefore, increase in connection resistance can be suppressed. When the cathode and the anode are welded by resistance welding with the conductive metallic foil interposed therebetween, the rigidity of a resistance welding site can be relieved as compared to the case where the cathode and the anode are welded by resistance welding without interposing the metallic foil. Therefore, connection intensity can be increased. In the fuel cell stack of the first exemplary embodiment, two cells are connected in series. However, the fuel cell stack is not limited thereto. In the fuel cell stack, according to the intended use, plural cells may be connected to one cell in parallel, or plural cells may be connected to plural cells in series or in parallel.

As the solid polymer electrolyte membrane, for example, one with high proton conductivity and without electron conductivity is preferable. As a constituent material of the solid polymer electrolyte membrane, it is preferable to use an ion-exchange resin including a polar group such as a strong acid group such as a sulfonic acid group, a phosphoric acid group, a phosphonic group, a phosphine group, and the like; or a weak acid group such as a carboxyl group and the like. Specific examples of the ion-exchange resin include perfluorosulfonic acid resin, sulfonated polyether sulfonic acid resin, sulfonated polyimide resin, sulfonated poly(4-phenoxybenzoyl-1,4-phenylene), sulfonated polyether ether ketone, sulfonated polyethersulfone, sulfonated polysulphone, sulfonated polyimide, alkyl sulfonated polybenzimidazole, and the like. The thickness of the solid polymer electrolyte membrane is not particularly limited and can be defined suitably according to intended use of the fuel cell or the material. The thickness of the membrane is, for example, in the range of about 5 μm to about 300 μm.

Examples of a material of the catalyst layer (hereinafter to be referred to as a catalyst material) include platinum, rhodium, palladium, iridium, osmium, ruthenium, rhenium, gold, silver, nickel, cobalt, molybdenum, lanthanum, strontium, yttrium, and the like. One of the catalyst materials may be used alone or two or more of them may be used in combination. The catalyst material is, for example, in the form of particle. The catalyst layer can be formed, for example, by applying particles (including powders) of the catalyst material supported by a supporter or particles of the catalyst material not supported by the supporter onto an electrode. The amount of the catalyst the range of about 0.1 mg/cm² to about 20 mg/cm² according to the type of the catalyst material or the size of the particles, for example. Examples of the supporter include particles of carbon-based material such as acetylene black, ketjen black, carbon nanotube, carbon nanohorn, and the like. The particle diameter of the carbon-based material is, for example, in the range of about 0.01 μm to about 0.1 μm, and is preferably in the range of about 0.02 μm to about 0.06 μm. A method of supporting the catalyst material by the supporter is not particularly limited, and an impregnation method can be applied, for example.

As represented by the formula (II), the cathode is, an electrode that reduces oxygen to water. The cathode is porous metal and has conductivity. As represented by the formula (I), the anode is, for example an electrode that generates protons (cations; H⁺), carbon dioxide (CO₂), and electrons (e⁻) from an aqueous methanol solution and water. The material, form, and the like of the anode are not particularly limited and are similar to those of the cathode, for example. Since the cathode and the anode are porous metal, fuel can be diffused. Examples of the metal include stainless, copper, gold, silver, aluminum, and the like. The form of the cathode is not particularly limited and the cathode is, for example, in the form of foil or in the form of sheet having the thickness in the range of about 0.05 mm to about 3.0 mm. The foil-like or sheet-like cathode is formed, for example, by entwining fibrous metallic wires having the wire diameter in the range of about 0.01 mm to about 2.0 mm. The cathode and the anode may be formed by suitably selecting the material and form as long as they are porous bodies including a space in which fuel can be diffused. The porosity of the cathode and the anode is, for example, in the range of about 5% to about 95%, is preferably in the range of about 50% to about 95%, and is more preferably in the range of about 70% to about 90%.

When the cathode and the anode are welded by resistance welding with the conductive metallic foil interposed therebetween, the cathode and the anode are connected. For example, if there is the press sign of an electrode for resistance welding in the cathode and the anode, it is understood that the cathode and the anode are connected by resistance welding. The specific resistance of the conductive metallic foil is preferably smaller than at least one of the specific resistance of the cathode and the specific resistance of the anode. This will make it possible to reduce the whole connection resistance between the cathode and the anode. As the conductive metallic foil, a foil of gold, silver, copper, aluminum, stainless, or their alloy can be used. Among them, a gold foil or a foil of alloy including gold as a main component is particularly preferable because it is small in an electric resistance value, excellent in ductility, and high in corrosion resistance.

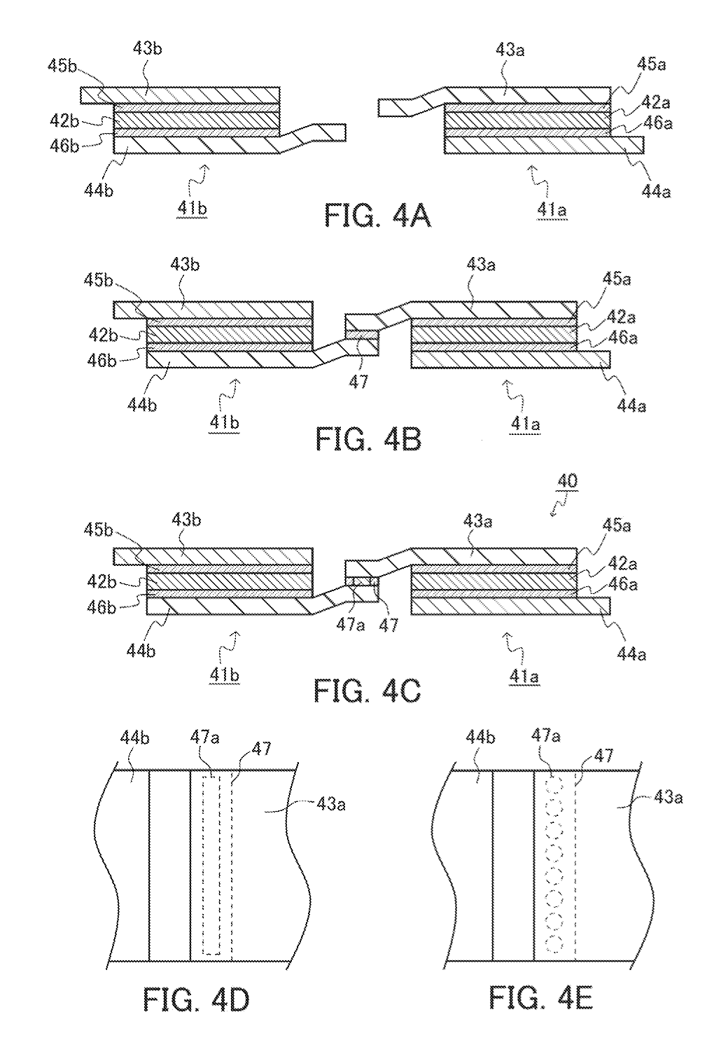

Next, on the bases of FIG. 4, a method of manufacturing a fuel cell stack of the first exemplary embodiment is explained. FIG. 4A shows a process of providing the cells. FIGS. 4B and 4C show a process of connecting the cells. FIGS. 4D and 4E show resistance welding sites. In FIGS. 4A to 4E, identical parts are indicated with identical numerals and symbols.

### <Process of Providing Cells>

First, a process of providing the cells is explained. As shown in FIG. 4A, cells 41a and 41b are provided. The cell 41a includes the following structure. That is, a porous metallic cathode 43a is arranged on one surface (upper surface in FIG. 4A) of a solid polymer electrolyte membrane 42a through a catalyst layer 45a. A porous metallic anode 44a is arranged on the other surface (lower surface in FIG. 4A) of the solid polymer electrolyte membrane 42a thorough a catalyst layer 46a. One end of the cathode 43a is protruded from one end (left end in FIG. 4A) of the solid polymer electrolyte membrane 42a. One end of the anode 44a is protruded from one end (right end in FIG. 4A) of the solid polymer electrolyte membrane 42a. The cell 41b includes a structure similar to that of the cell 41a. As the cells 41a and 41b, self-made products or commercially available products may be used.

### <Process of Connecting Cells>

Next, a process of connecting the cells is explained. As shown in FIG. 4B, a conductive metallic foil 47 is sandwiched between the protruded one end of the cathode 43a and the protruded one end of an anode 44b. In this condition, as shown in FIG. 4C, the cathode 43a and the anode 44b are welded by resistance welding. Due to the resistance welding, the conductive metallic foil 47 is welded and a resistance welding site 47a is formed. Thereby, two cells 41a and 41b are connected in an electrically conductive manner. In this manner, the fuel cell stack of the first exemplary embodiment can be manufactured. As shown in FIG. 4D, the resistance welding site 47a is linear. This will make it possible to increase connection intensity. However, the resistance welding is not limited to this example. For example, as shown in FIG. 4E, punctate resistance welding sites 47a may be formed in line. This will make it possible to connect cathode and anode readily. For example, an electrode including a spot diameter is used for forming such resistance welding site.

As described above, the conductive metallic foil is sandwiched between the cathode and the anode. Therefore, the thickness thereof is preferably about 1 mm or shorter. The conductive metallic foil includes one with thickness (conductive metallic plate). The conductive metallic foil may have the size (width and length) in which the cathode and the anode are not directly in contact with each other, or may have the length protruding from one end of the cells as long as the cells do not short out. Alternatively, the conductive metallic foil may be arranged only on a site between the cathode and the anode in which a resistance welding site is formed.

Further, at the time of resistance welding, it is not necessary that the conductive metallic foil itself is melted and fused with an electrode material. It is applicable as long as creation of holes due to electrode collapse can be prevented and electric resistance can be reduced.

The fuel cell stack of the first exemplary embodiment can be manufactured by the aforementioned method of manufacturing the fuel cell stack. However, a method of manufacturing the fuel cell stack of the first exemplary embodiment is not limited to the aforementioned method of manufacturing the fuel cell stack.

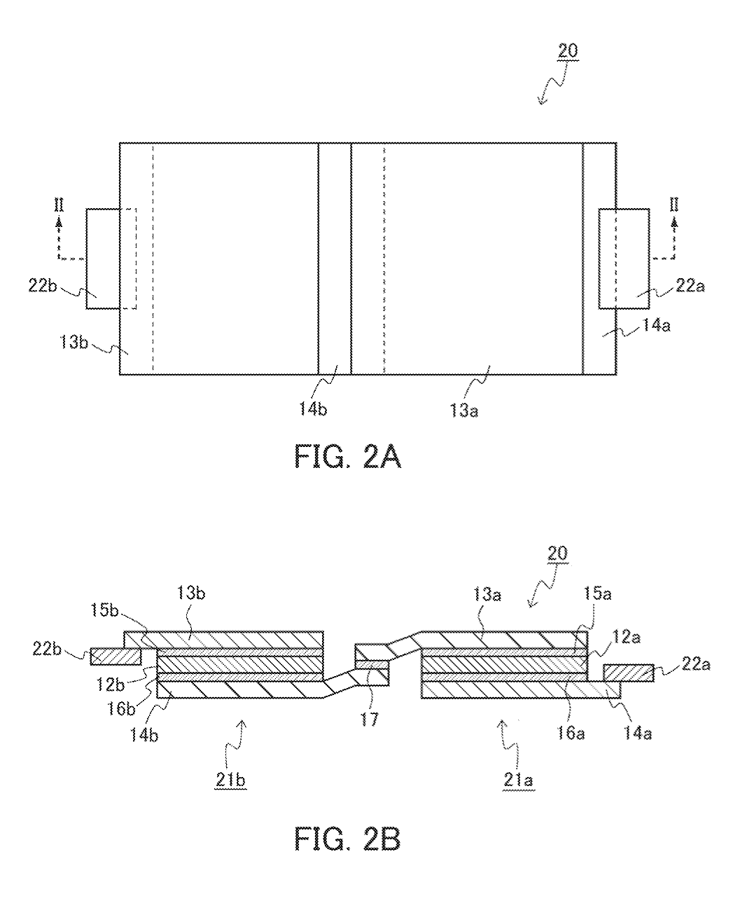

The fuel cell stack of the first exemplary embodiment may further be provided with a terminal for extracting electric power, for example. A structure of an example of this fuel cell stack is shown in FIG. 2. FIG. 2A is a plan view of the fuel cell stack. FIG. 2B is a cross-sectional view of the fuel cell stack taken along line II-II of FIG. 2A. In FIGS. 2A and 2B, identical parts to those shown in FIG. 1 are indicated with identical numerals and symbols. As shown in FIGS. 2A and 2B, a fuel cell stack 20 includes a terminal 22a, which is in contact with one surface (upper surface in FIG. 2B) of the protruded part of the anode 14a, and a terminal 22b, which is in contact with one surface (lower surface in FIG. 2B) of the protruded part of the cathode 13b. Other than these, the fuel cell stack 20 includes the structure similar to that of the fuel cell stack 10.

The terminal is preferably in contact with a cathode of the highest voltage and an anode of the lowest voltage. The material, form, structure, and the like of the terminal are not particularly limited. For example, a terminal, which is small in an electric resistance value and high in corrosion resistance, may be used.

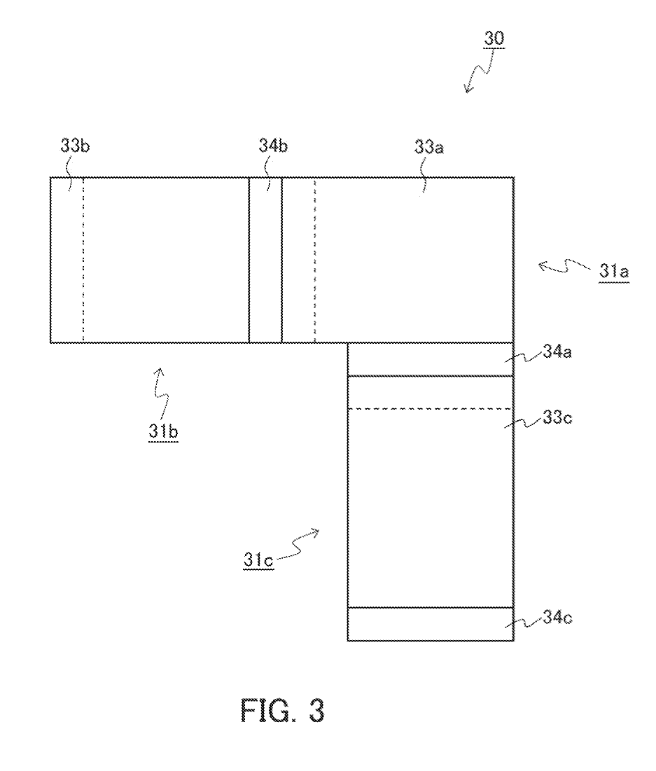

The fuel cell stack of the first exemplary embodiment may be provided with three or more cells. A structure of an example of such fuel cell stack is shown in FIG. 3. In FIG. 3, identical parts to those shown in FIG. 1 are indicated with identical numerals and symbols. As shown in FIG. 3, a fuel cell stack 30 is provided with cells 31a, 31b, and 31c. The cell 31a is provided with a cathode 33a, which includes a protruded part, and an anode 34a, which includes a protruded part in a direction perpendicular to a protruding direction of the cathode 33a (in a downward direction in FIG. 3). The cell 31a and the cell 31b are connected in an electrically conductive manner by resistance welding of the cathode 33a and an anode 34b (horizontal direction in FIG. 3). The cell 31a and the cell 31c are connected in an electrically conductive manner by resistance welding of a cathode 33c and the anode 34a (vertical direction in FIG. 3). This will make it possible to form a fuel cell stack in which cells are nonlinearly arranged. Other than these, the fuel cell stack 30 includes the structure similar to that of the fuel cell stack 10.

### A Second Exemplary Embodiment

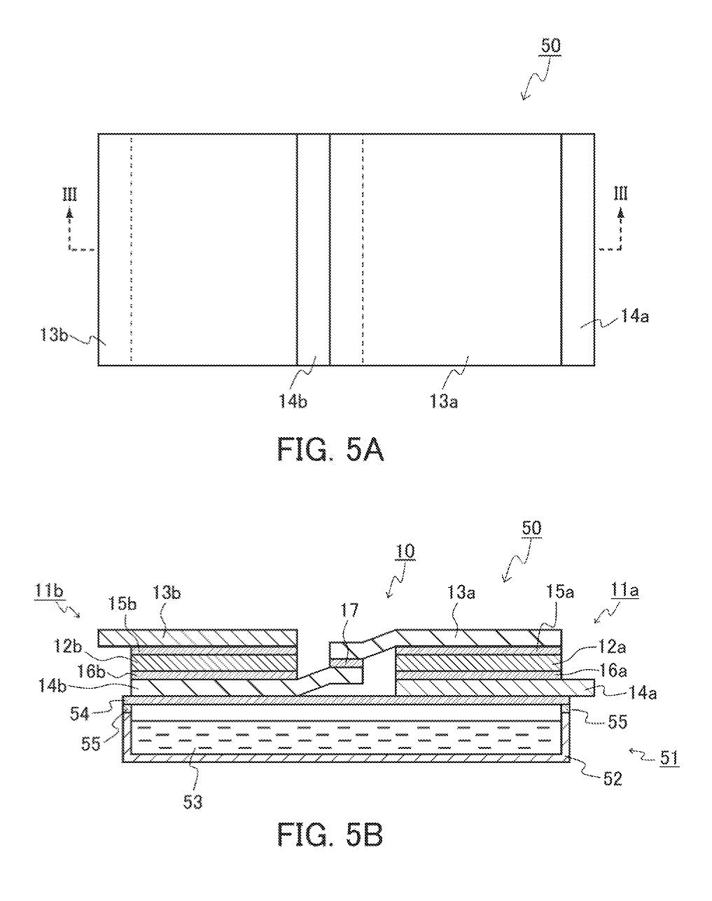

A structure of an example of a fuel cell of a second exemplary embodiment is shown in FIG. 5. FIG. 5A is a plan view of the fuel cell of the second exemplary embodiment. FIG. 5B is a cross-sectional view of the fuel cell taken along line of FIG. 5A. In FIGS. 5A and 5B, identical parts to those shown in FIG. 1 are indicated with identical numerals and symbols. As shown in FIGS. 5A and 5B, a fuel cell 50 is provided with a fuel cell stack 10 and a fuel supply portion 51 as main components. The fuel cell stack 10 is mounted to the fuel supply portion 51 in such a manner that the surface of the fuel cell stack 10 at the side of the anodes 14a and 14b (lower surface in FIG. 5B) faces the fuel supply portion 51. The fuel cell stack 10 is the aforementioned fuel cell stack. The fuel supply portion 51 includes a fuel container 52 and a gas-liquid separation membrane 54. The gas-liquid separation membrane 54 is applied to the surface of the fuel container 52 at the side of its opening (upper surface in FIG. 5B) through an adhesive tape 55. The fuel supply portion 51 is filled with liquid fuel 53 at the time of using. In the fuel cell of the second exemplary embodiment, the liquid fuel is vaporized and supplied to the anode through the gas-liquid separation membrane. Further, in the fuel cell of the second exemplary embodiment, since the aforementioned fuel cell stack is used, fuel vaporization at a connection site can be reduced. As a result, in the fuel cell of the second exemplary embodiment, an electric resistance value of the whole fuel cell stack can be reduced and fuel efficiency at the time of electric power generation can be improved. The fuel cell of the second exemplary embodiment includes an inlet and an outlet for the liquid fuel at the side surface or the bottom surface of the fuel container, although they are not shown. The fuel cell of the second exemplary embodiment is not limited to the aforementioned fuel cell of vaporization supply type.

The material, form, structure, and the like of the fuel supply portion are not particularly limited. In consideration of leak of the liquid fuel, for example, the fuel supply portion includes a structure in which the fuel container, which includes an opening at one surface of a cuboid, is applied with the gas-liquid separation membrane at the opening thereof with a thermocompression tape. Preferably, an area of the opening of the fuel container is approximately equal to an area in which catalyst layers of the anodes 14a and 14b are formed.

The material of the gas-liquid separation membrane is not particularly limited, and is applicable as long as liquid fuel in the fuel container can be transmitted in the vaporized form. For example, a hydrophobic PTFE porous membrane, a hydrophilic electrolyte membrane for filter), or the like can be used as the gas-liquid separation membrane.

Examples of the liquid fuel include alcohol fuel such as methanol, ethanol, and the like; ether fuel such as dimethyl ether, diethyl ether, and the like; and the like. The fuel cell of the second exemplary embodiment is, for example, a direct methanol fuel cell that directly uses an aqueous methanol solution as the liquid fuel. The liquid fuel is supplied to the anode in the vaporized form through the gas-liquid separation membrane.

For example, a fuel retention material, which is called a wicking material, may be inserted into the fuel container. The wicking material is used mainly in aim of absorbing and retaining liquid fuel by capillary action and supplying fuel to an anode. The wicking material is not particularly limited and examples thereof include woven, nonwoven, fibrous mat, fibrous web, expandable polymer, and the like. Among them, expandable materials of a polymer-based material such as urethane, PVF material, and the like are particularly preferable.

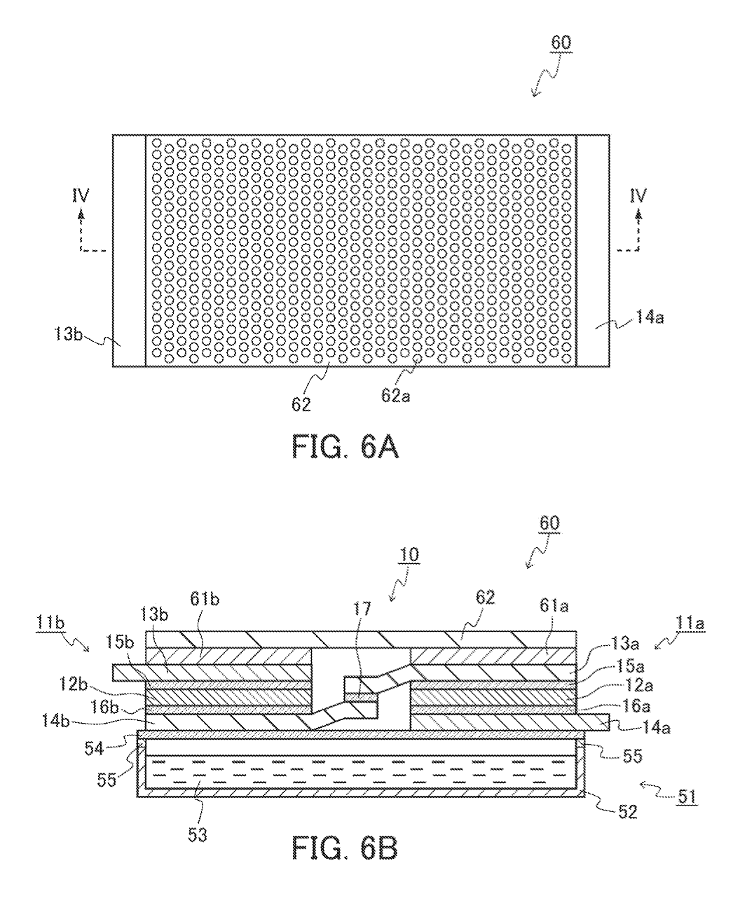

The fuel cell of the second exemplary embodiment may further be provided with a moisture retention layer, which contains fibrous nonwoven, and a plate member, which includes plural pores, for example. A structure of an example of such fuel cell is shown in FIG. 6. FIG. 6A is a plan view of the fuel cell. FIG. 6B is a cross-sectional view of the fuel cell taken along line IV-IV of FIG. 6A. In FIGS. 6A and 6B, identical parts to those shown in FIG. 5 are indicated with identical numerals and symbols. As shown in FIGS. 6A and 6B, in a fuel cell 60, a moisture retention layer 61a is arranged on a surface of the cell 11a at the side of the cathode 13a (upper surface in FIG. 6B). A moisture retention layer 61b is arranged on a surface of the fuel cell 11b at the side of the cathode 13b (upper surface in FIG. 6B). A plate member 62 including pores 62a, which are formed in a staggered manner, is arranged on surfaces of the moisture retention layers 61a and 61b on the side opposed from the cathodes (upper surface in FIG. 6B). This will make it possible to reduce moisture release at the side of the cathodes. Other than these, the fuel cell 60 includes the structure similar to that of the fuel cell 50. In FIG. 6B, the cross-sectional structures of the pores 62a are not shown for easier understanding of the figure.

The moisture retention layer is applicable as long as it includes fibrous nonwoven that can moderately retain or release moisture and does not hinder diffusion of gas containing oxygen to cathodes during electric power generation. For example, cellulose nonwoven is suitable for the moisture retention layer.

For example, a metallic plate such as aluminum, which is applied with anticorrosion treatment with paint at the surface thereof, is suitable for the plate member. The opening diameter and aperture ratio of the pores are not particularly limited.

A method of manufacturing the aforementioned fuel cell is not particularly limited. The aforementioned fuel cell can be manufactured by manufacturing the aforementioned fuel cell stack by the aforementioned method of manufacturing the fuel cell stack, and mounting the aforementioned fuel cell stack to the fuel supply portion using a conventionally known method.

### EXAMPLE

An example of the present invention is explained together with a reference example. The present invention is neither specified nor limited by the following example or reference example.

### A First Example

A fuel cell shown in FIG. 6 was manufactured. Hereinafter, the structure of the fuel cell used in a first example is explained.

### <Preparation of Cell>

### (1) Cathode

First, catalyst supporting carbon fine particles in which platinum fine particles having the particle diameter in the range of 3 to 5 nm were supported by carbon particles (“Ketjen Black EC 600 JD” (trade name), manufactured by Lion Corporation) were provided. The amount of the platinum fine particles was 50% by weight. To 1 g of the catalyst supporting carbon fine particles, 5% by weight of NAFION® dispersion solution (product No. “DE521”, manufactured by DUPONT) was added and stirred. Thereby, a catalyst paste for forming cathode was obtained. On the other hand, a porous metallic sheet (made of stainless, size of 4.2 cm×4.0 cm, thickness of 0.2 mm, and porosity of 80%) was provided. Short sides of the porous metallic sheet were covered with tapes having the width of 0.2 cm and thereby a catalyst application area of 4.0 cm×4.0 cm was formed. On a hot plate, which was set at a temperature equal to or lower than a glass-transition temperature of NAFION® contained in the catalyst paste, this porous metallic sheet was placed and heated. In this state, the catalyst paste was applied to the porous metallic sheet with an application amount of 1 to 8 mg/cm². In this manner, a cathode 13a provided with a catalyst layer 15a was prepared.

### (2) Anode

An anode 14a provided with a catalyst layer 16a was prepared in the same manner as the cathode except that platinum (Pt)-ruthenium (Ru) alloy fine particles (proportion of Ru being 50 at %) having the particle diameter in the range of 3 to 5 nm were used instead of the platinum fine particles, and the amount of the NAFION® dispersion solution added to the catalyst supporting carbon fine particles was ¾ of the NAFION® dispersion solution used in the preparation of the cathode.

### (3) Solid Polymer Electrolyte Membrane

As a solid polymer electrolyte membrane 12a, “NAFION® 117” (trade name), manufactured by DUPONT (average molecular weight of 250000, size of 4.5 cm×4.5 cm, and thickness of 180 μm) was provided.

### (4) Cell

The cathode 13a was arranged on one surface of the solid polymer electrolyte membrane 12a in such a manner that the surface of the cathode 13a on which a catalyst layer 15a was not provided faced outward. The anode 14a was arranged on the other surface of the solid polymer electrolyte membrane 12a in such a manner that the surface of the anode 14a on which a catalyst layer 16a was not provided faced outward. Pressure was added from the outside of each electrode by hot pressing in a condition where surfaces of the electrodes on which catalyst layers were provided were faced to each other through the solid polymer electrolyte membrane 12a. At this time, parts of the electrode on which catalyst layers were not provided were placed at opposite sides. A part of the solid polymer electrolyte membrane 12a protruded from the surface of the electrodes on which the catalyst layers were provided was cut off by leaving about 0.2 mm. Alternatively, the part of the solid polymer electrolyte membrane 12a protruded from the surface of the electrodes was cut off 0.2 mm or shorter as required. In this manner, the cell 11a was prepared. The cell lib was prepared in the same manner as the cell 11a.

### <Preparation of Fuel Cell Stack>

First, the cells 11a and 11b were arranged such that the cathode 13a of the cell 11a and the anode 14b of the cell lib were overlapped about 1.5 mm. A ribbon-like gold foil 17 (size of 1.3.mm×4.0 cm, and thickness of 0.1 mm) was sandwiched between the cathode 13a and the anode 14b. With respect to a part in which the gold foil was sandwiched, using an electrode having a circular cross-section (diameter size of 0.7 mm), punctate resistance welding sites were formed in line, and the cathode 13a and the anode 14b were welded by resistance welding. In this manner, a fuel cell stack 10 was prepared.

### <Preparation of Fuel Supply Portion>

A container (outer size of 8.5 cm×4.5 cm×0.7 mm, and thickness of 0.2 mm) made of polyether ether ketone (PEEK) having an opening at the maximum surface was provided as a fuel container 52. A porous membrane (thickness of 50 μm, and porosity of 90%) made of PTFE was provided as a gas-liquid separation membrane 54. The gas-liquid separation membrane 54 was applied to the opened surface of the fuel container 52 through adhesion tapes 55. In this manner, a fuel supply portion 51 which can store liquid fuel without leaking was prepared. The fuel supply portion 51 was filled with 10% by volume of aqueous methanol solution 53.

### <Preparation of Fuel Cell>

The fuel cell stack 10 was mounted to the fuel supply portion 51 in such a manner that the surface of the fuel cell stack 10 at the side of the anodes 14a and 14b were placed on the gas-liquid separation membrane 54. On the both cathodes 13a and 13b of the cells 11a and 11b, cellulose nonwovens (size of 4.0 cm×4.0 cm, thickness of 0.2 mm) were arranged as moisture retention layers 61a and 61b. On the upper surfaces of the moisture retention layers 61a and 61b, an aluminum perforated plate (outer size of 8.5 cm×4.5 cm×0.7 mm, and porosity of 50%) was placed as a plate member 62. All these components were fixed with shredded tapes so as to be a single member. In this manner, a fuel cell 60 was prepared.

### A Reference Example

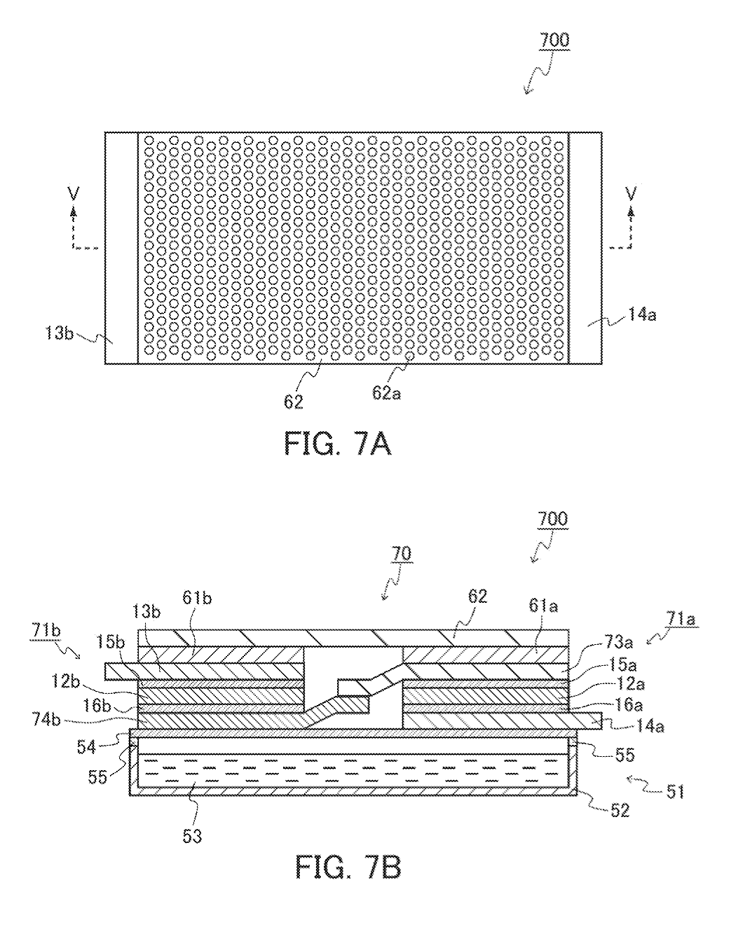

As shown in FIG. 7, a fuel cell 700 of a reference example was prepared in the same manner as the first example except that a fuel cell stack 70 was prepared by directly welding a cathode 73a and an anode 74b by resistance welding without sandwiching a conductive metallic foil therebetween.

### <Operation of Fuel Cell>

Each fuel cell of the first example and the reference example was attached with an external circuit. In this state, electric power generation was performed. The following electric power generation properties in each fuel cell were measured or calculated. Specifically, the maximum power of the fuel cell was measured by monitoring current values in a condition where the voltage was swept from an open voltage to 0V at 5 mV/sec. Further, after measurement of the maximum power, series resistance was measured by performing impedance determination. Maximum power density values converted from the maximum power and measurement values of the series resistance are summarized in Table 1. Furthermore, changes in voltage and fuel consumption rate at constant current of 30 mA/cm², 60 mA/cm², and 90 mA/cm² were measured. However, in each current condition, electric power generation was stopped when the voltage became 400 mV, 300 mV, and 200 mV. Measurement results of the voltage and the fuel consumption rate are summarized in Table 2.

TABLE 1

| | Maximum power density | Series resistance |
|---|---|---|
| | (mW/cm²) | (mΩ) |
| First example | 50.2 | 75 |
| Reference example | 40.1 | 100 |

TABLE 2

| | Current | Voltage (V) at each time | | | | Fuel consumption |
|---|---|---|---|---|---|---|
| | density | 30 | 60 | 90 | 120 | rate |
| | (mA/cm²) | min | min | min | min | (g/h) |
| First | 30 | 1.10 | 1.08 | 1.00 | — | 0.9 |
| example | 60 | 0.90 | 0.88 | — | — | 1.2 |
| | 90 | 0.76 | 0.60 | — | — | 1.3 |
| Reference | 30 | 1.05 | 1.00 | 0.95 | — | 1.2 |
| example | 60 | 0.85 | 0.80 | — | — | 1.4 |
| | 90 | 0.71 | — | — | — | 1.5 |

As summarized in Table 1, the maximum power density of the fuel cell of the first example is about 20% higher than that of the fuel cell of the reference example. Further, the series resistance of the fuel cell of the first example is about 25% lower than that of the fuel cell of the reference example. These results show that resistance loss at a resistance welding site was improved by configuring the fuel cell as described above, and power output was thereby improved.

As summarized in Table 2, in any constant current condition, the voltage of the fuel cell of the first example was higher than that of the fuel cell of the reference example at a given time. Particularly in higher current, marked difference was observed. Further, in any constant current condition, the fuel cell of the first example showed better result in fuel consumption rate than the fuel cell of the reference example. That is, it was found that the fuel cell of the first example was high in power output and long in electric power generation time, and could suppress fuel consumption. These results show that power output was improved and fuel vaporization at a resistance welding site was suppressed by configuring the fuel cell as described above.

Accordingly, as shown in examples, it can be found that fuel cell performance is improved by configuring the fuel cell as described above. Particularly, it can be found that the fuel cell configured as described above are effective in reduction of resistance between cells and can obtain suppression effect of fuel vaporization.

The related art described in the background art causes a problem such as complexity of the structure of the fuel cell stack, limitation of the size of the fuel cell stack, or the like because it is provided with the aforementioned rivet, the power collector, or the like. In order to solve such problem, for example, there is a method in which a part of an anode and a part of a cathode of two or more cells are directly welded by resistance welding or the like. In a case where a carbon sheet is used as an electrode of the cell, it is difficult to weld the electrode itself by resistance welding or the like. Therefore, it is preferable that the material of the anode and the cathode of the fuel cell is metallic fibrous mat, porous metal, or the like, which can be welded by the resistance welding. However, when electrodes made of such material are directly welded by the resistance welding, a connection area is limited. Therefore, as compared to a case in which flat plates are welded by the resistance welding or the like, connection resistance at a connection site may be increased, and the connection site may be damaged due to low connection intensity.

An exemplary advantage according to the invention is to provide a fuel cell stack that has a simple structure, suppresses increase in connection resistance at a connection site of a cathode and an anode, and achieves high connection intensity at the connection site. The fuel cell stack having such excellent performance can be manufactured by the aforementioned method of manufacturing the fuel cell stack. However, a method of manufacturing the aforementioned fuel cell stack is not limited to the aforementioned method of manufacturing the fuel cell stack.

The aforementioned fuel cell stack includes a simple structure, suppresses increase in connection resistance at a connection site of a cathode and an anode, and is high in connection intensity at the connection site. Therefore, examples of the use of the aforementioned fuel cell provided with the aforementioned fuel cell stack include a power source of small devices such as cell-phones, notebook computers, and the like; stationary external battery chargers; household power sources; industrial power sources used in factories; and the like. However, the use thereof is not particularly limited and is applicable over a wide range of fields.

While the invention has been particularly shown and described with reference to exemplary embodiment thereof, the invention is not limited to these embodiments. It will be understood by those of ordinary skill in the art that various changes in form and details may be made therein without departing from spirit and scope of the present invention as defined by the claims.

1. A fuel cell stack comprising:
two or more cells comprising:
a solid polymer electrolyte membrane;
a porous metallic cathode; and
a porous metallic anode, wherein
said cathode is arranged on one surface of said solid polymer electrolyte membrane through a catalyst layer,
said anode is arranged on the other surface of said solid polymer electrolyte membrane through a catalyst layer, and
said two or more cells are connected in an electrically conductive manner by resistance welding of said cathode of one of said cells and said anode of the other one of said cells with a conductive metallic foil interposed therebetween.

2. The fuel cell stack according to claim 1, wherein one end of said cathode is protruded from said solid polymer electrolyte membrane,
one end of said anode is protruded from said solid polymer electrolyte membrane, and
two or more cells are connected in an electrically conductive manner by resistance welding of said protruded one end of cathode and said protruded one end of anode with said conductive metallic foil interposed therebetween.

3. The fuel cell stack according to claim 1, wherein specific resistance of said conductive metallic foil is smaller than at least one of specific resistance of said cathode and specific resistance of said anode.

4. The fuel cell stack according to claim 1, wherein said conductive metallic foil comprises gold foil.

5. A fuel cell comprising:
said fuel cell stack according to claim 1; and
a fuel supply portion,
said fuel supply portion comprising:
a fuel container; and
a gas-liquid separation membrane, wherein
said fuel supply portion is arranged at an anode side of said fuel cell stack through said gas-liquid separation membrane, and
gaseous fuel is supplied from said fuel supply portion to said anode through said gas-liquid separation membrane.

6. The fuel cell according to claim 5, further comprising:
a moisture retention layer containing fibrous nonwoven; and
a plate member including a plurality of pores, wherein
said moisture retention layer is arranged on a cathode side of said fuel cell stack, said plate member is arranged on said moisture retention layer opposite from said cathode side of said fuel cell stack.

7. A method of manufacturing a fuel cell stack comprising:
providing two or more cells,
said two or more cells comprising:
a solid polymer electrolyte membrane;
a porous metallic cathode; and
a porous metallic anode, said cathode being arranged on one surface of said solid polymer electrolyte membrane through a catalyst layer, and said anode being arranged on the other surface of said solid polymer electrolyte membrane through a catalyst layer; and
connecting said two or more cells in an electrically conductive manner by resistance welding of said cathode of one of said cells and said anode of the other one of said cells with a conductive metallic foil interposed therebetween.

8. The method of manufacturing a fuel cell stack according to claim 7, wherein, in said providing, two or more cells are provided in which one end of said cathode is protruded from said solid polymer electrolyte membrane and one end of said anode is protruded from said solid polymer electrolyte membrane, and in said connecting, said two or more cells are connected in an electrically conductive manner by resistance welding of said protruded one end of cathode and said protruded one end of anode with said conductive metallic foil interposed therebetween.

9. The method of manufacturing a fuel cell stack according to claim 7, wherein, in said connecting, said resistance welding is performed by forming a punctate resistance welding site.

10. The method of manufacturing a fuel cell stack according to claim 7, wherein, in said connecting, said resistance welding is performed by forming a linear resistance welding site.
